(19) United States
(12) Patent Application Publication
(10) Pub. No.: US 2020/0088886 A1
(43) Pub. Date: Mar. 19, 2020

(54) CONTROL TERMINAL AND CONTROL METHOD THEREOF, MOVABLE PLATFORM AND CONTROL METHOD THEREOF

(71) Applicant: SZ DJI TECHNOLOGY CO., LTD., Shenzhen (CN)

(72) Inventors: Wei ZHANG, Shenzhen (CN); Renli SHI, Shenzhen (CN); Meng HU, Shenzhen (CN); Liuzheng CUI, Shenzhen (CN)

(21) Appl. No.: 16/694,001

(22) Filed: Nov. 25, 2019

Related U.S. Application Data
(63) Continuation of application No. PCT/CN2017/086581, filed on May 31, 2017.

(51) Int. Cl. G01S 19/07; G01S 19/41; G01S 19/23

(52) U.S. Cl. CPC G01S 19/071; G01S 19/23; G01S 19/41

(57) ABSTRACT

A method includes receiving a multiple signal message (“MSM”). The method also includes constructing multiple sub-MSM units based on the MSM. The method further includes transmitting the multiple sub-MSM units to a movable platform.

### CROSS-REFERENCE TO RELATED APPLICATION

This application is a continuation application of International Application No. PCT/CN2017/086581, filed on May 31, 2017, the entire content of which is incorporated herein by reference.

### TECHNICAL FIELD

The present disclosure relates to the technology field of global navigation satellite system and, more particularly, to a control terminal and a control method thereof, and a movable platform and a control method thereof.

### BACKGROUND

Differential global navigation satellite system (“DGNSS”) includes three components: a base station, a data communication link, and a movable station (e.g., a user device). Based on the principle of positioning in DGNSS, the base station may generate differential correction information (e.g., a pseudo range, carrier phase differential data), and transmit the differential correction information to the movable station through a standard protocol. Currently, the base station primarily uses the Radio Technical Commission for Maritime Service (“RTCM”) protocol to transmit the differential correction information to the movable station. The current standard format is RTCM V3.2. The compilation and correction of RTCM V3.2 not only corrected deficiencies in the previous versions, but also added and expanded multiple network Real Time Kinematic (“RTK”) information, including Multiple Signal Messages (“MSM”) of GPS, GLONNASS, GALILEO, and BDS. The MSM can not only support the DGNSS/RTK information included in the previous format, but also can realize real-time transmission and storing an observation value based on the RINEX format of the network.

However, when the base station uses the MSM of the RTCM V3.2 to transmit the differential correction information, if a portion of the data included in a frame of MSM has errors, the entire frame of MSM may become unusable. In particular, when the base station wirelessly transmits the MSM, because the wireless transmission is susceptible to errors, the base station may not accomplish differential positioning based on the received MSM.

### SUMMARY

In accordance with an aspect of the present disclosure, there is provided a method including receiving a multiple signal message (“MSM”). The method also includes constructing multiple sub-MSM units based on the MSM. The method further includes transmitting the multiple sub-MSM units to a movable platform.

In accordance with another aspect of the present disclosure, there is provided a control terminal. The control terminal includes a communication interface configured to receive a multiple signal message (“MSM”). The control terminal also includes one or more processors configured to operate independently or in combination to construct multiple sub-MSM units based on the MSM. The one or more processors are also configured to transmit the multiple sub-MSM units to a movable platform.

According to the technical solutions of the present disclosure, after the control terminal receives the MSM, the control terminal may construct multiple sub-MSM units based on the MSM. The multiple sub-MSM units may be transmitted to a movable platform, thereby effectively reducing the correlation between the data. After the movable platform receives the multiple sub-MSM units, the MSM may be reconstructed based on the received multiple sub-MSM units. Thus, one or more of the multiple sub-MSM units have errors or are lost during the transmission, the movable platform may reconstruct the MSM based on other sub-MSM units, and accomplish differential positioning based on the reconstructed MSM, thereby enhancing the fault-tolerance capability and reliability of MSM transmission.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a control method of a control terminal, according to an example embodiment.

FIG. 2 is a schematic illustration of application scene, according to an example embodiment.

FIG. 3 is another schematic illustration of application scene, according to an example embodiment.

FIG. 4 is a flow chart illustrating a control method of a control terminal, according to another example embodiment.

FIG. 5 is a schematic illustration of constructing sub-MSM units, according to an example embodiment.

FIG. 6 is a schematic diagram of a format of a sub-MSM unit that includes a frame head of the MSM and sub-MSM units that include satellite data and signal data of the MSM, according to an example embodiment.

FIG. 7 is a flow chart illustrating a control method of a control terminal, according to another example embodiment.

FIG. 8 is a schematic diagram of a format of a sub-MSM unit that includes a frame end, according to an example embodiment.

FIG. 9 is a flow chart illustrating a control method of movable platform, according to an example embodiment.

FIG. 10 is a flow chart illustrating a control method of movable platform, according to another example embodiment.

FIG. 11 is a flow chart illustrating a control method of movable platform, according to another example embodiment.

FIG. 12 is a flow chart illustrating a control method of movable platform, according to another example embodiment.

FIG. 13 is a schematic diagram of a control terminal, according to another example embodiment.

FIG. 14 is a schematic diagram of a movable platform, according to another example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, the embodiments of the present disclosure will be described in detail. Unless there is obvious conflict, the various embodiments or various features of various embodiments may be combined.

Currently, the RTCM V3.2 protocol defines seven types of MSMs: MSM1, MSM2, MSM3, MSM4, MSM5, MSM6, MSM7. The MSMs of various navigation positioning systems may include the same structure. The arrangement sequence of the internal modules is also substantially the same. The detailed structure is shown in Table 1:

TABLE 1
Frame format of an MSM

| | | | |
|---|---|---|---|
| MSM Header | Satellite data | Signal data | Check code |

The MSM includes an MSM header, satellite data, signal data, and a check code. The MSM header may include all information relating to the satellite and the signals transmitted by the MSM. The satellite data may include all shared satellite data (e.g., rough range) of all information of any satellite. The signal data may include all specific signal data (e.g., precise carrier phase range) of each signal. The check code may be used to check or verify the MSM.

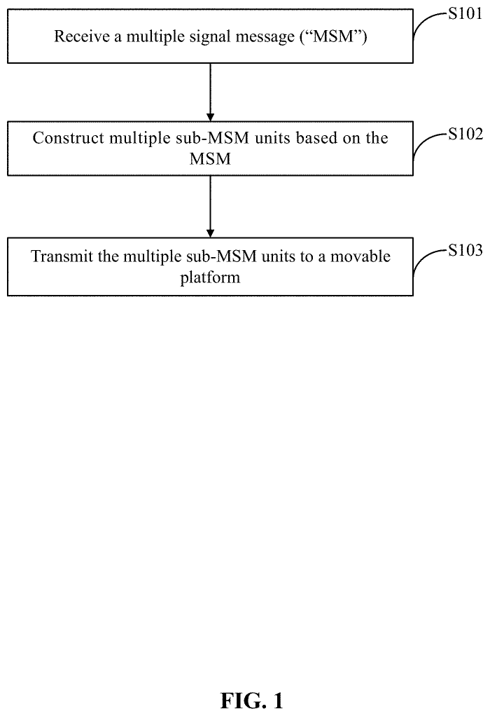

The present disclosure provides a control method implemented by a control terminal (or a control method of a control terminal, or a control method for a control terminal). FIG. 1 is a flow chart illustrating a control method implemented by a control terminal. As shown in FIG. 1, the method may include:

S101: receiving an MSM.

In some embodiments, the control terminal may be one or more of dedicated remote controller of a movable platform (e.g., an unmanned aerial vehicle), a smart cell phone, a tablet, a laptop, a ground based control station, a wearable device (e.g., a watch or a wristband). The control terminal may be provided with a corresponding communication interface, and may receive the MSM through the communication interface.

In some embodiments, the control terminal may receive the MSM through one or more of the following practical methods:

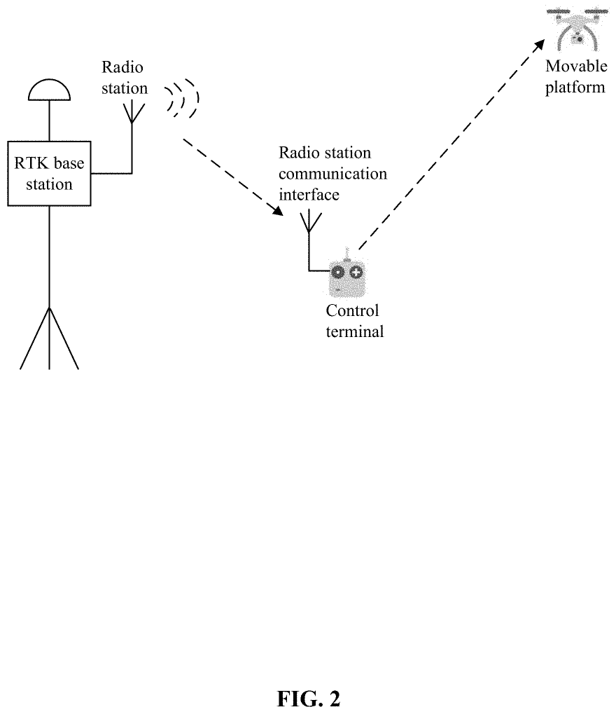

One practical method: receiving MSM transmitted by a radio station of an RTK base station. As shown in FIG. 2, the RTK base station (i.e., the base station mentioned above) may be provided with a radio station or the RTK base station may be connected with the radio station. The control terminal may be provided with a radio station communication interface. When the RTK base station broadcasts the MSMs through the radio station, the control terminal may receive the MSMs broadcasted through the radio station through the radio station communication interface.

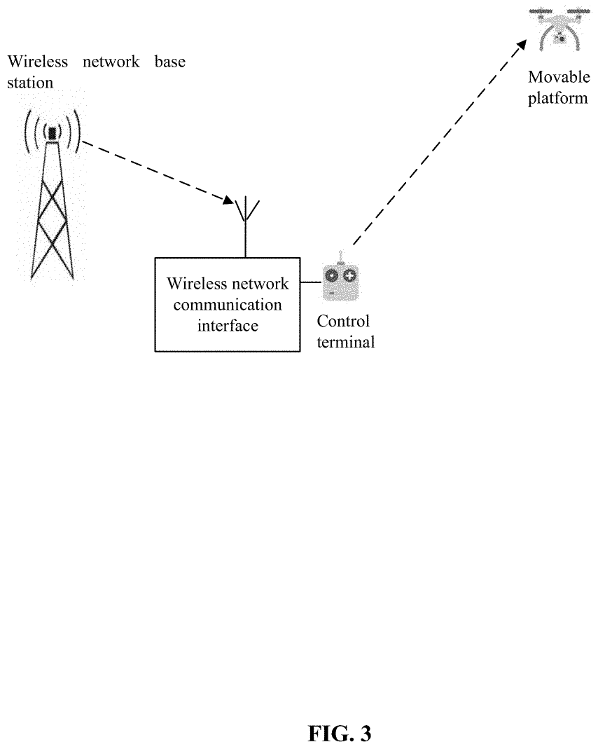

Another practical method: receiving the MSM transmitted by a wireless network base station. As shown in FIG. 3, the wireless network base station may communicate with the control terminal through a wireless network, such as the second generation mobile communication technology (2G), 3G, or 4G, or other standard communication network, such that the control terminal may receive the MSMs transmitted by the wireless network base station. For example, the control terminal may be provided with a wireless network communication interface. Through the wireless network communication interface, the control terminal may establish a wireless network data connection with the wireless network base station, such that the control terminal may receive the MSMs transmitted by the wireless network base station based on the wireless network data connection.

In some embodiments, as shown in FIG. 2 and FIG. 3, for the convenience of understanding, the radio station communication interface, the wireless network communication interface, and the control terminal are drawn separately, which is only for illustrative purposes. In some embodiments, the radio station communication interface and the wireless network communication interface may be a functional device of the control terminal, and may not be mutually independent from the control terminal.

S102: construct multiple sub-MSM units based on the MSM.

In some embodiments, after the movable platform receives the MSM transmitted by the control terminal, if a portion of the data of the received MSM has errors or if an error occurred during receiving the MSM, then the entire received frame of MSM may be unusable. As such, in some embodiments, after the control terminal receives the MSM, the data of the MSM may be split. Data obtained after the splitting may be used to construct multiple sub-MSM units. That is, the data obtained after splitting may be placed in different sub-MSM units. This may reduce the correlation between the data. In other words, the fault-tolerance capability of the MSM during the transmission may be increased through the constructed multiple sub-MSM units.

S103: transmitting the multiple sub-MSM units to a movable platform.

In some embodiments, after a processor of the control terminal constructs the multiple sub-MSM units, the control terminal may transmit the multiple sub-MSM units to the movable platform through an uplink data link, such that the movable platform may accomplish differential positioning based on the multiple sub-MSM units. In some embodiments, the uplink data link may be based on Wireless Fidelity (“WI-FI”) of IEEE 802.11b standard, software defined radio (“SDR”), or any other self-defined protocol.

In some embodiments, after the multiple sub-MSM units are constructed, the multiple sub-MSM units may be encrypted. For example, an encryption algorithm, such as a symmetric encryption algorithm or an asymmetric encryption algorithm, may be used to encrypt the sub-MSM units. When encrypting the sub-MSM units, positioning data (e.g., satellite data or signal data) included in the sub-MSM unit may be encrypted, or an entire sub-MSM unit may be encrypted. In some embodiments, whenever a sub-MSM unit is constructed, the constructed sub-MSM unit may be encrypted. In other words, the construction of the sub-MSM unit and the encryption of the sub-MSM unit may be performed simultaneously. In some embodiments, after all of the sub-MSM units are constructed, all of the sub-MSM units may be encrypted in a sequence or simultaneously, to ensure the security of these sub-MSM units. Correspondingly, transmitted multiple sub-MSM units to the movable platform may include: transmitting multiple encrypted sub-MSM units to the movable platform.

In some embodiments, according to the technical solution of the present disclosure, after the control terminal receives an MSM, the control terminal may construct multiple sub-MSM units based on the MSM, and may transmit the multiple sub-MSM units to the movable platform. This may effectively reduce the correlation between the data. After the movable platform receives the multiple sub-MSM units, an MSM may be reconstructed based on the multiple sub-MSM units. As such, if one or more of the multiple sub-MSM units have errors or are lost during transmission, the movable platform may reconstruct the MSM based on other sub-MSM units, and accomplish differential positioning based on the reconstructed MSM, thereby improving the fault tolerance capability and reliability of the MSM transmission.

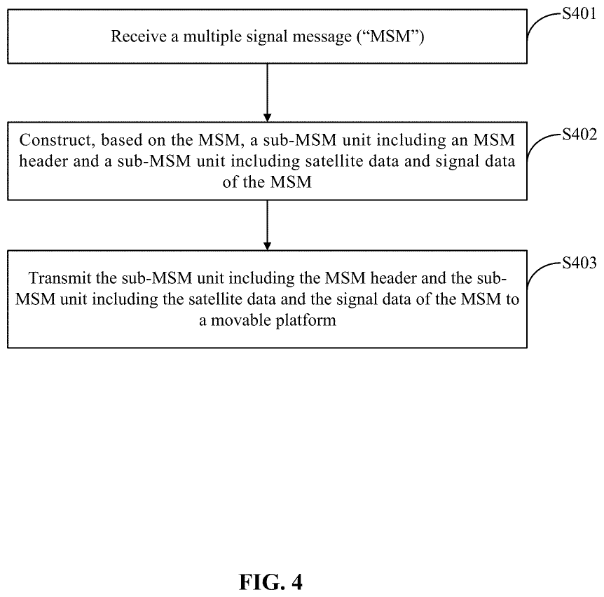

In some embodiments, the present disclosure provides a control method implemented by a control terminal. FIG. 4 is a flow chart illustrating a control method of the control terminal. As shown in FIG. 4, based on the embodiment shown in FIG. 1, the method shown in FIG. 4 may include:

Step S401: receiving an MSM.

The detailed method and principle of Step S401 may be consistent with those of step S101, which are not repeated.

S402: constructing, based on the MSM, a sub-MSM unit including an MSM header, and a sub-MSM unit including satellite data and signal data of the MSM.

In some embodiments, the construction process may include: obtaining the MSM header, and construct a sub-MSM unit including the MSM header; obtaining the satellite data and the signal data included in the MSM, and construct a sub-MSM unit including the satellite data and the signal data included in the MSM. In some embodiments, after the control terminal receives the MSM, based on the structural feature of the frame of the MSM, the processor of the control terminal may separate the MSM header from the MSM, and may construct a sub-MSM unit including the MSM header. The processor of the control terminal may separate the satellite data and the signal data from the MSM, and may construct a sub-MSM unit including the satellite data and the signal data.

In some embodiments, obtaining the satellite data and the signal data from the MSM, and construct the sub-MSM unit including the satellite data and the signal data may include: grouping the satellite data and the signal data to determine the satellite data and the signal data corresponding to each satellite; and constructing a sub-MSM unit including the satellite data and the signal data corresponding to each satellite.

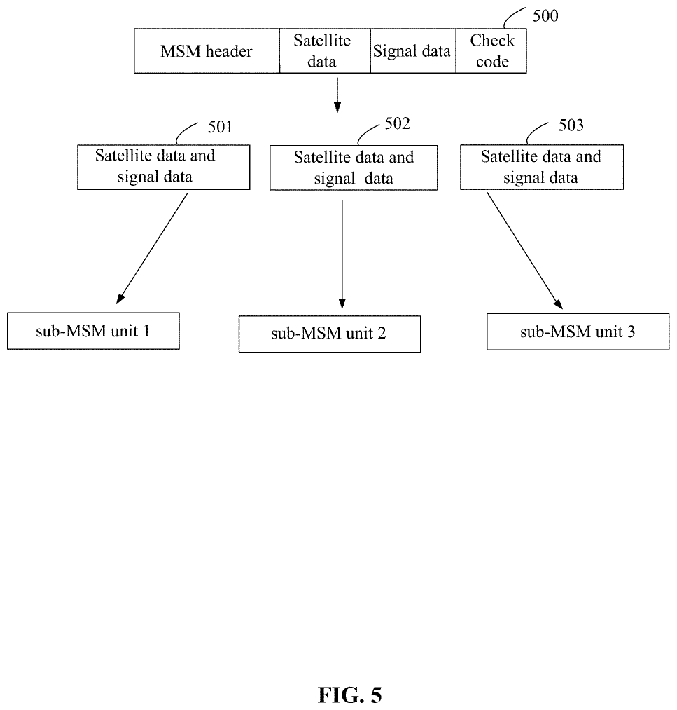

In some embodiments, as shown in FIG. 5, the control terminal may receive a frame of MSM. The processor of the control terminal may obtain the satellite data and the signal data from the MSM. The processor may group the satellite data and the signal data using satellite as a unit, and may obtain the satellite data and the signal data corresponding to each satellite from the MSM. For example, the satellite may be a visible satellite. The MSM may include three visible satellites. For illustrative purposes, the three visible satellites may be labeled as number 1, number 5, and number 8. The processor may determine the satellite data and the signal data 501 corresponding to the number 1 satellite from the MSM, the satellite data and the signal data 502 corresponding to the number 5 satellite from the MSM, and the satellite data and the signal data 503 corresponding to the number 8 satellite from the MSM. The processor may construct a sub-MSM unit 1 based on the satellite data and signal data 501, construct a sub-MSM unit 2 based on the satellite data signal data 502, and construct a sub-MSM unit 3 based on the satellite data and signal data 503. As such, if the movable platform receives only two of the three sub-MSM units, or receives error data of one sub-MSM unit of the three sub-MSM units, the processor may still accomplish differential positioning based on the satellite data and signal data of the remaining two sub-MSM units.

Next, the detailed format of the multiple sub-MSM units constructed based on an MSM.

In some embodiments, the sub-MSM may include a header. In some embodiments, the header may include relevant information of the sub-MSM unit, such as one or more of a modulation mode, a data length, or a type of the sub-MSM unit (e.g., whether the sub-MSM unit includes the MSM header, or the satellite data and signal data of the MSM).

In some embodiments, each sub-MSM unit may include a check code. When the control terminal constructs the sub-MSM units, the control terminal may add a check code in each sub-MSM unit. The movable platform may verify whether there is an error in the satellite data and the signal data included in the received sub-MSM unit through the check code. One practical format of the check code is the cyclic redundancy check (“CRC”) code.

In some embodiments, the sub-MSM unit including the satellite data and the signal data of the MSM may include identification information. The identification information may be determined based on the satellite numbering (or the numbering of the satellite). For example, the identification information may indicate which satellite the satellite data and the signal data included in the sub-MSM unit belong to. The processor of the control terminal may analyze the MSM header to obtain the satellite numbering, and determine the identification information based on the satellite numbering, and insert the determined identification information into the sub-MSM unit including the satellite data and the signal data of the MSM. After the movable platform receives multiple sub-MSM units, based on the identification information of the sub-MSM unit including the satellite data and the signal data and the MSM header included in the sub-MSM unit, the movable platform may compare the identification information and the with the satellite numbering included in the MSM header, to determine, among a number of sub-MSM units including the satellite data and the signal data that are lost or that have error data, which satellites correspond to the sub-MSM units including the satellite data and the signal data that are lost or that have error data.

In some embodiments, determining the identification information based on the satellite numbering may be implemented through the following practical methods:

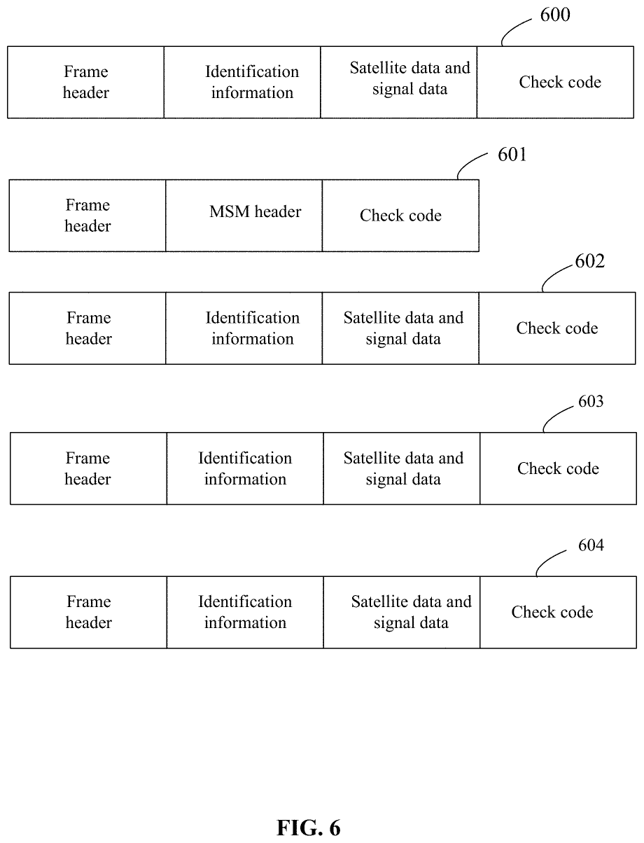

One practical method: the satellite numbering is used as the identification information of the sub-MSM unit including the satellite data and the signal data of the MSM. For example, as shown in FIG. 6, the control terminal may receive a frame of MSM 600. If the frame of MSM includes three visible satellites, assuming the three visible satellites are numbered as a number 1 satellite, a number 5 satellite, and a number 8 satellite, based on the satellite numbering of the three visible satellites, the identification information of a sub-MSM unit 601, a sub-MSM unit 602, and a sub-MSM unit 603 may be determined as 1, 5, and 8 respectively. After the movable platform receives a sub-MSM unit having the MSM header, the movable platform may obtain the satellite numbering from the MSM header, such as obtaining the number 1 satellite, the number 5 satellite, and the number 8 satellite of the visible satellites. If the movable platform only receives the sub-MSM unit 601 whose identification information is 1 and the sub-MSM unit 603 whose identification information is 8, then the movable platform may determine, based on the received satellite numbering, that the sub-MSM unit 602 of the satellite number 5 is lost.

Another practical method: a serial number corresponding to the satellite numbering may be used as the identification information of the sub-MSM unit including the satellite data and the signal data of the MSM. For example, referring to FIG. 6, assuming that the three visible satellites are numbered as number 1 satellite, number 5 satellite, and number 8 satellite. The identification information of the sub-MSM unit 601, the sub-MSM unit 602, and the sub-MSM unit 603 may be determined as 1, 2, and 3 based on the satellite numbering. After the movable platform receives the sub-MSM unit including the MSM header, the movable platform may obtain the satellite numbering from the MSM header, i.e., obtain the number 1 satellite, the number 5 satellite, and the number 8 satellite. If the movable platform only receives the sub-MSM unit 601 whose identification information is 1, and the sub-MSM unit 603 whose identification information is 3, the movable platform may determine, based on the satellite numbering, that the sub-MSM unit 602 whose identification information is 2 is lost.

In some embodiments, the identification information may be located in an empty bit formed when the satellite data and the signal data of the MSM are combined. For example, when constructing the sub-MSM unit based on the satellite data and the signal data, the satellite data and the signal data may be combined. The length of the combined data should be an integer multiple of 8 bits. Otherwise, there may be empty bits. When there is an empty bit, the empty bit may be filled such that the length of the data is an integer multiple of 8 bits. The current movable station (i.e., the positioning device of the movable platform) typically uses a single-frequency or double-frequency receiver. Therefore, only 1 signal data and 2 signal data need to be considered. Table 2 shows the number of bits of the satellite data and the signal data of different types of MSM.

TABLE 2
Number of bits of satellite data and signal data of MSM

| | MSM4 | MSM5 | MSM6 | MSM7 |
|---|---|---|---|---|
| Number of bits | 18 | 36 | 18 | 36 |
| of satellite data | | | | |
| Number of bits | 48 | 63 | 65 | 80 |
| of signal data | | | | |

Using MSM4 as an example to consider the situation of one signal data, the number of bits after the satellite data and the signal data of the MSM are combined is 18+48=66. Accordingly, 6 empty bits need to be filled to make the number of bits of the sub-MSM unit to be an integer multiple of 8 bits.

Next, consider the situation of two signal data. The number of bits of the constructed sub-MSM unit is 18+48*2=114. Accordingly, 6 empty bits need to be filled to make the number of bits of the sub-MSM to be an integer multiple of 8 bits. Table 3 shows the number of empty bits when constructing the sub-MSM based on the different types of MSM.

TABLE 3
Number of empty bits when constructing sub-MSM from MSM

| | MSM4 | MSM5 | MSM6 | MSM7 |
|---|---|---|---|---|
| 1 signal | 6 | 5 | 5 | 4 |
| 2 signals | 6 | 6 | 4 | 4 |

For current receivers, the number of visible satellites included in the received MSM is typically no more than 16. As such, the number of bits occupied by the identification information is no more than 4. From the Table 3, a person having ordinary skills in the art can understand that the number of empty bits formed by constructing the sub-MSM is not less than 4. Therefore, the identification information may be placed in the empty bits of the sub-MSM unit, to save the number of transmission bytes.

In is understood that placing the identification information before the satellite data and the signal data as shown in FIG. 6 is only for illustrative purpose. A person having ordinary skills in the art can use other placement methods, which are not limited in the present disclosure.

S403: transmitting the sub-MSM unit including the MSM header and the sub-MSM unit including the satellite data and the signal data of the MSM to a movable platform.

In some embodiments, after constructing the sub-MSM including the MSM header and the sub-MSM including the satellite data and the signal data of the MSM, the control terminal may transmit, through an uplink data link, to the movable platform the sub-MSM unit including the MSM header and the sub-MSM unit including the satellite data and the signal data of the MSM. When reconstructing the MSM based on the received sub-MSM units, the movable platform may analyze the sub-MSM including the MSM header to obtain the MSM header, and reconstruct the MSM based on the MSM header. If the movable platform cannot receive the sub-MSM unit including the MSM header, the movable platform may not be able to reconstruct the MSM. As such, under the condition that the wireless transmission data bandwidth need is satisfied between the control terminal and the movable platform, transmitting the sub-MSM unit including the MSM header to the movable platform may include: transmitting the sub-MSM unit including the MSM header to the movable platform multiple times. Through the redundant transmission method, it is ensured that the movable platform can receive the sub-MSM unit including the MSM header, thereby increasing the probability of the movable platform receiving the sub-MSM unit including the MSM header.

The present disclosure is not limited to the method of transmitting the sub-MSM unit including the MSM header multiple times. In some embodiments, a response mechanism may be used. That is, after the control terminal transmits the sub-MSM unit including the MSM header, if the control terminal does not receive a response from the movable platform within a predetermined time period (which may be preset based on actual applications), the control terminal may re-transmit the sub-MSM unit including the MSM header. As compared to the proactively transmitting the sub-MSM unit including the MSM header multiple times, in this method the control terminal needs to wait for the response from the movable platform, and this method is more complex.

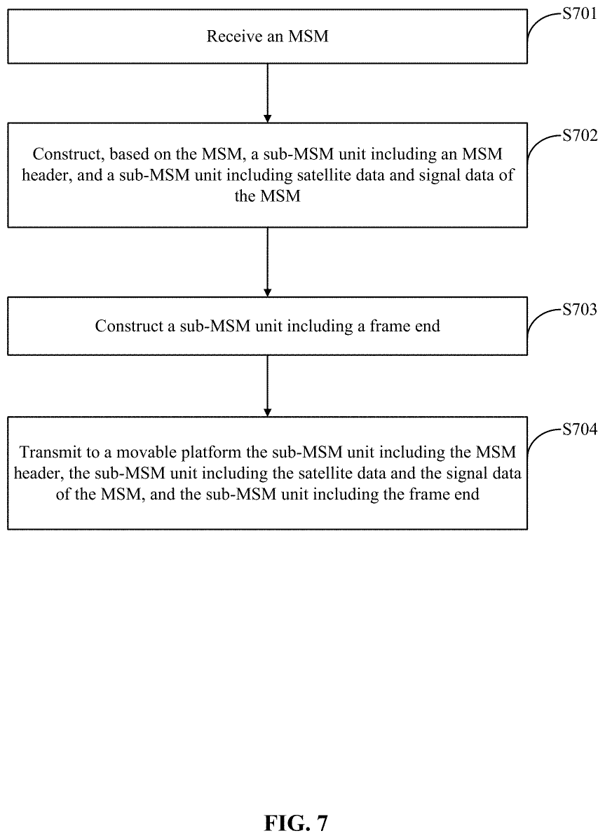

The present disclosure provides another control method of the control terminal. FIG. 7 shows a flow chart illustrating another control method implemented by the control terminal. As shown in FIG. 7, based on the embodiments of FIG. 1 and FIG. 4, this embodiment of the method may include:

Step S701: receiving an MSM.

The detailed method and principle of step S701 may be consistent with those of step S101, which are not repeated.

S702: constructing, based on the MSM, a sub-MSM unit including an MSM header and a sub-MSM unit including satellite data and signal data of the MSM.

The detailed method and principle of step S702 may be consistent with those of step S402, which are not repeated.

S703: constructing a sub-MSM unit including a frame end.

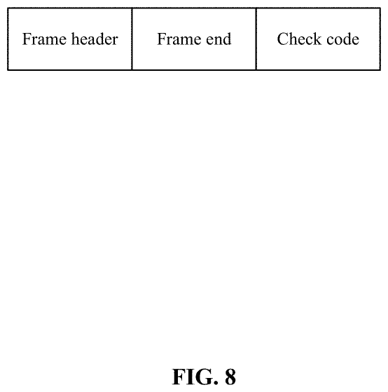

In some embodiments, constructing the sub-MSM unit including the frame end is to instruct the control terminal to complete transmitting the sub-MSM unit to the movable platform. An example format of the sub-MSM unit including the frame end is shown in FIG. 8. In some embodiments, the frame end may occupy 1 byte to save the number of transmission bytes. The number of bits occupied by the frame end may be far smaller than the number of bits occupied by the satellite data and the signal data of the sub-MSM unit that include the satellite data and the signal data of the MSM. As such, through this, the control terminal may determine whether the currently transmitted sub-MSM unit is the sub-MSM unit including the frame end, thereby determining whether the transmission is completed.

S704: transmitting to a movable platform the sub-MSM unit including the MSM header, the sub-MSM unit including the satellite data and the signal data of the MSM, and the sub-MSM unit including the frame end.

In some embodiments, first, the sub-MSM unit including the MSM header may be transmitted to the movable platform (which may be transmitted multiple times). After completing the transmission of the sub-MSM unit including the MSM header, the sub-MSM unit including the satellite data and the signal data of the MSM may be transmitted. Finally, the sub-MSM unit including the frame end may be transmitted.

In some embodiments, the movable platform may determine whether the transmission is completed based on the sub-MSM unit including the frame end. Under the condition that the wireless transmission data bandwidth need is satisfied between the control terminal and the movable platform, transmitting the sub-MSM unit including the frame end to the movable platform may include: transmitting the sub-MSM unit including the frame end to the movable platform multiple times. Through this redundant transmission method, it can be ensured that the movable platform can receive the sub-MSM including the frame end, thereby increasing the probability of the movable platform receiving the sub-MSM unit including the frame end.

The present disclosure is not limited to the method of transmitting the sub-MSM unit including the frame end to multiple times. In some embodiments, a response mechanism may be used. That is, after the control terminal transmits the sub-MSM unit including the frame end to the movable platform, if the control terminal does not receive the response from the movable platform within a predetermined time period (which may be preset based on the actual applications), the control terminal may re-transmit the sub-MSM unit including the frame end. Compared to the method of proactively transmitting the sub-MSM unit including the frame end multiple times, in this method, the control terminal needs to wait for the response from the movable platform, and this method is more complex.

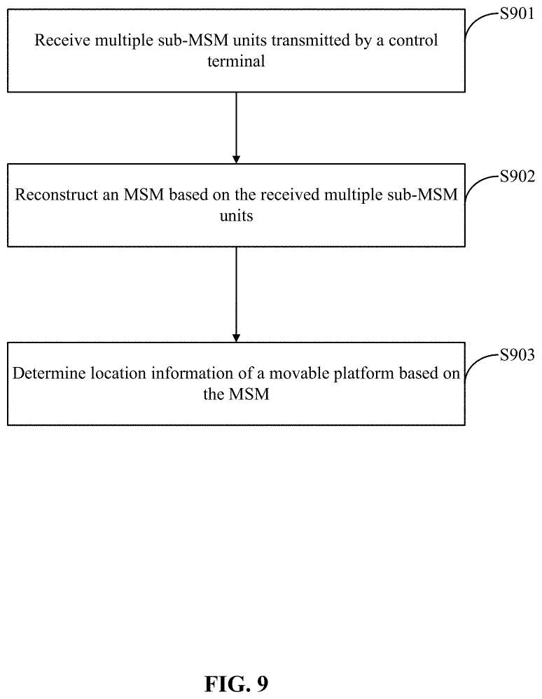

The present disclosure provides a control method for a movable platform. FIG. 9 is a flow chart illustrating a control method of the movable platform. As shown in FIG. 9, the method may include:

S901: receiving multiple sub-MSM units transmitted by a control terminal.

In some embodiments, the movable platform may be any of the above-mentioned movable stations. For example, the movable platform may be a ground-based robot (e.g., a remotely controlled vehicle), an aerial robot (e.g., an unmanned aerial vehicle), a water surface robot (e.g., a remotely controlled boat), etc. As described above, the control terminal may transmit the multiple sub-MSM units to the movable platform through an uplink data link. The movable platform may receive the multiple sub-MSM units. The multiple sub-MSM units may be constructed based on the received MSM. The detailed method for constructing the sub-MSM unites based on the received MSM can refer to the above descriptions, which are not repeated.

S902: reconstructing an MSM based on the received multiple sub-MSM units.

In some embodiments, after receiving the multiple sub-MSM units, the processor of the movable platform may reconstruct the MSM based on the format characteristics of the MSM and based on the multiple sub-MSM units. The reconstructed MSM satisfies the standard MSM format requirement.

S903: determining location information of a movable platform based on the MSM.

In some embodiments, the movable platform may be provided with a positioning device, such as a GNSS receiver. After the movable platform reconstruct the MSM, the movable platform may perform a differential analysis based on the data output by the GNSS and the reconstructed MSM to determine the location information of the movable platform.

In some embodiments, the received sub-MSM unit may be decrypted based on a predetermined decryption rule. Reconstructing the MSM based on the received multiple sub-MSM units may include: reconstructing the MSM based on the multiple decrypted sub-MSM units.

In some embodiments, if the control terminal encrypts and transmits a sub-MSM unit constructed based on the MSM, the processor of the movable platform may decrypt the received sub-MSM based on the predetermined decryption rule, and reconstruct the MSM based on the decrypted multiple sub-MSM units. The predetermined decryption rule may correspond to the encryption rule at the control terminal side, which is not repeated.

According to the above technical solution, after the control terminal receives the MSM, the control terminal may construct multiple sub-MSM units based on the MSM, and may transmit the multiple sub-MSM units to the movable platform, thereby reducing the correlation between the data of the MSM. After the movable platform receives the multiple sub-MSM units, the movable platform may reconstruct the MSM based on the multiple sub-MSM units. Accordingly, in the process of the control terminal transmitting the multiple sub-MSM units to the movable platform, if one or more of the multiple sub-MSM units have error or are lost, the movable platform may still be able to reconstruct the MSM based on other sub-MSM units, thereby increasing the fault tolerance capability and reliability of the MSM transmission.

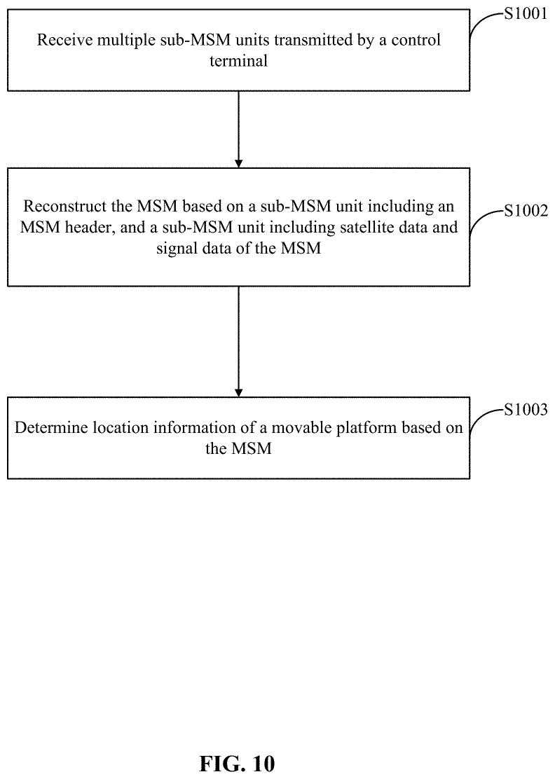

The present disclosure provides a control method of a movable platform. FIG. 10 is a flow chart illustrating a control method of a movable platform. As shown in FIG. 10, based on the embodiment shown in FIG. 9, this embodiment of the method may include:

S1001: receiving multiple sub-MSM units transmitted by a control terminal.

The detailed method and the principle of step S1001 may be consistent with those of step S901, which are not repeated.

S1002: when the multiple sub-MSM units include at least a sub-MSM unit including an MSM header, a sub-MSM unit including satellite data and signal data of an MSM, reconstructing the MSM based on the received sub-MSM unit including the MSM header and the sub-MSM unit including the satellite data and the signal data of the MSM.

In some embodiments, as described above, the control terminal may construct the sub-MSM unit including the MSM header and the sub-MSM unit including the satellite data and the signal data of the MSM based on the MSM, and may transmit the sub-MSM unit including the MSM header and the sub-MSM unit including the satellite data and the signal data including the MSM to the movable platform. The movable platform may reconstruct the MSM based on the two sub-MSM units. The reconstructed MSM may satisfy the standard MSM format requirement.

In some embodiments, reconstructing the MSM based on the sub-MSM unit including the MSM header and the sub-MSM unit including the satellite data and the signal data of the MSM may include: obtaining the MSM header from the sub-MSM unit including the MSM header, obtaining the satellite data and the signal data included in the sub-MSM unit including the satellite data and the signal data of the MSM, and reconstructing the MSM based on the MSM header, the satellite data, and the signal data. In some embodiments, the processor of the movable platform may separate the MSM header from the sub-MSM unit including the MSM header, and separate the satellite data and the signal data from the sub-MSM unit including the satellite data and the signal data of the MSM. Then the processor of the movable platform may reconstruct the MSM based on the MSM header, the satellite data, and the signal data according to the standard MSM format requirement.

In some embodiments, the satellite data and the signal data included in each sub-MSM that includes the satellite data and the signal data of the MSM are the satellite data and the signal data of a corresponding satellite included in the MSM. Obtaining the satellite data and the signal data of the sub-MSM unit that includes the satellite data and the signal data of the MSM may include: obtaining satellite data and signal data corresponding to a satellite from each sub-MSM unit that includes the satellite data and the signal data of the MSM. Reconstructing the MSM based on the MSM header, the satellite data, and the signal data may include: reconstructing the MSM based on the MSM header, the satellite data and the signal data corresponding to each satellite. In some embodiments, each sub-MSM unit that includes the satellite data and the signal data of the MSM may include satellite data and signal data of a satellite. The movable platform may obtain the satellite data and the signal data corresponding to each satellite, combine the satellite data of each satellite, and combine the signal data of each satellite data. The movable platform may reconstruct the MSM based on the MSM header, the combined satellite data, and the combined signal data based on the standard MSM format requirement.

In some embodiments, the multiple sub-MSM units may include a frame header or header. After the sub-MSM unit is received, the frame header of the sub-MSM unit may be analyzed. The movable platform may obtain one or more of the modulation mode, data length, and type of the sub-MSM unit (e.g., whether the sub-MSM unit includes the MSM header or the satellite data and the signal data of the MSM).

In some embodiments, multiple sub-MSM units may include: a sub-MSM unit including the frame end. After the sub-MSM unit including the frame end is received, the MSM may be reconstructed based on the received sub-MSM unit including the MSM header, and the sub-MSM unit including the satellite data and the signal data of the MSM.

In some embodiments, when the sub-MSM unit including the frame end is received, it indicates that the control terminal has transmitted all of the sub-MSM units constructed based on the MSM. Then the movable platform may reconstruct the MSM based on the received multiple sub-MSM units.

S1003: determining location information of a movable platform based on the MSM.

The detailed method and the principle of step S1003 may be consistent with those of step S903, which are not repeated.

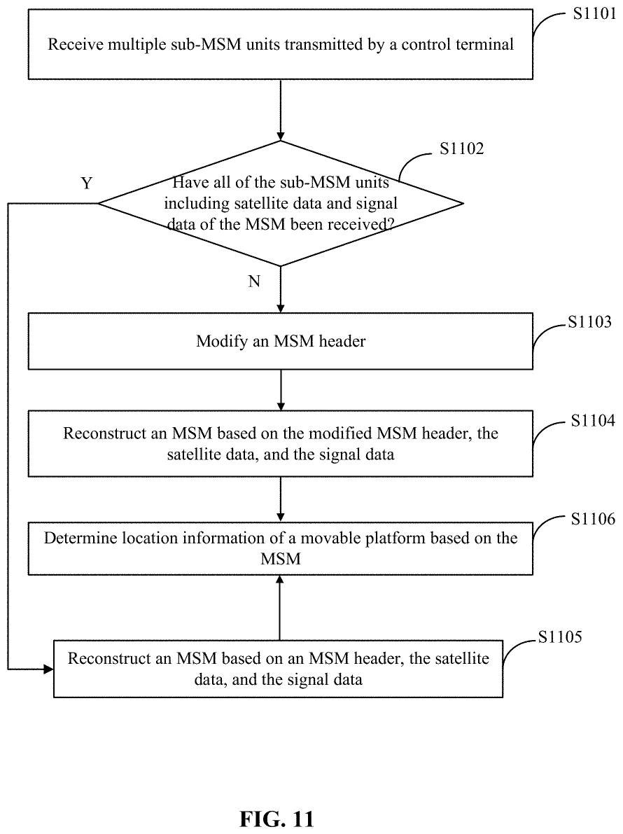

The present disclosure provides another embodiment of a control method of a movable platform. FIG. 11 is a flow chart illustrating another embodiment of the control method of the movable platform. As shown in FIG. 11, on the basis of the embodiments shown in FIG. 9, FIG. 10, this embodiment of the method may include:

S1101: receiving multiple sub-MSM units transmitted by a control terminal.

The detailed method and the principle of step S1101 may be consistent with those of step S901, which are not repeated.

S1102: determining whether all of the sub-MSM units constructed based on the MSM and including the satellite data and the signal data of the MSM have been received. If not all have been received, step 1103 may be executed. If all have been received, step 1105 may be executed.

In some embodiments, prior to reconstruct the MSM based on the received multiple sub-MSM units, the processor of the movable platform may determine all of the sub-MSM units constructed based on the MSM and including the satellite data and the signal data of the MSM have been received, i.e., determine the satellite data and the signal data of which satellite or satellites have been lost.

In some embodiments, the sub-MSM unit including the satellite data and the signal data of the MSM may include identification information. The identification information may be determined based on the numbering of the satellite. As such, determining whether all of the sub-MSM units constructed based on the MSM and including the satellite data and the signal data of the MSM have been received may include: obtaining the identification information of the sub-MSM unit that includes the satellite data and the signal data of the MSM; determining, based on the MSM header and the identification information, whether all of the sub-MSM units constructed based on the MSM and including the satellite data and the signal data of the MSM have been received.

In some embodiments, as described above, the satellite data and the signal data of each sub-MSM unit that includes the satellite data and the signal data of the MSM may be the satellite data and the signal data of a corresponding satellite. In addition, the sub-MSM unit that includes the satellite data and the signal data of the MSM may include identification information. The identification information may be compared with the satellite numbering included in the MSM header to determine how many sub-MSM units including the satellite data and the signal data of the MSM have been lost, or specifically, the sub-MSM unit including the satellite data and the signal data corresponding to which satellite has been lost. The detailed process may refer to the previous descriptions, which is not repeated.

In some embodiments, the identification information may be located in an empty bit formed when combing the satellite data and the signal data of the MSM. As such, the identification information may be obtained from the empty bits formed when combining the satellite data and the signal data of the MSM. The reason for forming the empty bits when constructing the sub-MSM unit can refer to the previous descriptions of the previous embodiments.

S1103: modifying an MSM header.

In some embodiments, the processor of the movable platform may analyze the MSM header to learn that the MSM includes three visible satellites. Assuming that the three satellites are numbered as number 1 satellite, number 5 satellite, and number 8 satellite. If analyzing the identification information of the sub-MSM unit that includes the satellite data and the signal data of the MSM reveals that currently only the sub-MSM unit whose identification information is 1 and the sub-MSM unit whose identification information is 3 are received, then, as described above, it may be determined that the sub-MSM unit whose identification information is 2 is lost, i.e., the satellite data and the signal data of the satellite whose numbering is 5 are lost. As such, currently, only the satellite data and the signal data of two visible satellites are received. Since the current MSM header indicate that there are three visible satellites, the MSM header may be modified. The modification may include modifying one or more of the satellite numbering, and the number of signal data of the MSM. The modification may be realized by modifying one or more of the satellite mask, the signal mask, or the cell mask of the MSM header.

S1104: reconstructing an MSM based on the modified MSM header, the satellite data, and the signal data.

In some embodiments, after obtaining the modified MSM header, the information of the modified MSM header may match with the received satellite data and the signal data. The MSM may be reconstructed based on the obtained satellite data and the signal data.

S1105: reconstructing an MSM based on the MSM header, the satellite data, and the signal data.

In some embodiments, if all of the sub-MSM units constructed based on the MSM and including the satellite data and the signal data of the MSM have been received, then the MSM header may not need be modified. In other words, when the satellite data and the signal data of all of the visible satellites indicated by the MSM header have been received, the MSM may be directly reconstructed based on the received satellite data, the signal data, and the MSM header.

S1106: determining location information of a movable platform based on the MSM.

The detailed method and principle of step S1106 may be consistent with those of step S903, which are not repeated.

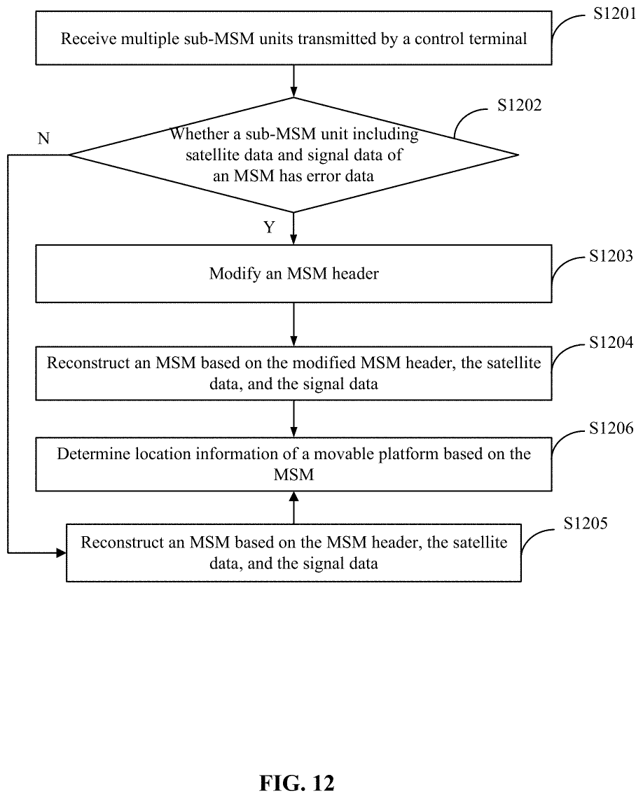

The present disclosure provides another embodiment of a control method of a movable platform. FIG. 12 is a flow chart illustrating another embodiment of the control method of the movable platform. As shown in FIG. 12, on the basis of the embodiments shown in FIG. 9, FIG. 10, and FIG. 11, this embodiment of the method may include:

S1201: receiving multiple sub-MSM units transmitted by a control terminal.

The detailed methods and principle of step S1201 may be consistent with those of step S901, which are not repeated.

S1202: if the sub-MSM unit includes a check code, determining, based on the check code, whether a sub-MSM unit that includes the satellite data and the signal data of the MSM has error data. If there are error data, step S1203 may be executed; if there are no error data, step S1205 may be executed.

In some embodiments, if the sub-MSM unit includes a check code, after receiving the multiple sub-MSM units, the processor of the movable platform may determine, based on the check code, whether a sub-MSM unit including the satellite data and the signal data of the MSM includes error data.

In some embodiments, the identification information may be located at an empty bit formed when combining the satellite data and the signal data of the MSM. Therefore, the identification information may be obtained from the empty bit formed when combining the satellite data and the signal data of the MSM. The reason why the empty bit may be formed when constructing the sub-MSM can refer to the relevant description of the previous embodiments.

S1203: modifying an MSM header.

In some embodiments, the MSM header may be modified based on the MSM header, and the identification information obtained from the sub-MSM unit including the satellite data and the signal data of the MSM that does not include error data. As described above, the satellite data and the signal data of each sub-MSM unit including the satellite data and signal data of the MSM may be satellite data and signal data of a corresponding satellite. In addition, the sub-MSM unit including the satellite data and the signal data of the MSM may include identification information. The identification information may be determined based on the satellite numbering. The identification information may be obtained from a sub-MSM unit including the satellite data and the signal data of the MSM that does not include error data. The identification information may be compared with the satellite numbering included in the MSM header to determine how many sub-MSM units including the satellite data and the signal data of the MSM have error data, or more specifically, the satellite data and the signal data of which satellite(s) have error data.

For example, if the processor of the movable platform analyzes the MSM header to learn that the MSM includes three visible satellites, the three visible satellites may be assumed to be a number 1 satellite, a number 5 satellite, and a number 8 satellite. However, if analysis of the identification information of the sub-MSM unit including the satellite data and the signal data of the MSM that does not include error data indicate that the sub-MSM unit whose current identification information is 1 and the sub-MSM unit whose current identification information is 3 do not have error data, it may be determined that the sub-MSM unit whose current identification information is 2 has error data. In other words, it may be determined that the sub-MSM unit that includes satellite data and signal data of number 5 satellite has error data. The satellite data and the signal data of the number 5 satellite may not be used. AS such, currently, the satellite data and the signal data of only two visible satellites do not have error data. However, the current MSM header indicates that there are three visible satellites. Therefore, the MSM header may be modified. In some embodiments, one or more of the satellite numbering and the number of signal data included in the MSM header may be modified. For example, one or more of the satellite mask, signal mask, or cell mask included in the MSM header may be modified.

S1204: reconstructing an MSM based on the modified MSM header, and the satellite data and the signal data of the sub-MSM unit that does not include error data.

In some embodiments, after obtaining the modified MSM header, the information of the modified MSM header may match with the satellite data and the signal data of the sub-MSM unit that does not include error data. The MSM may be reconstructed based on the satellite data and the signal data of the sub-MSM unit that does not include error data.

S1205: reconstructing the MSM based on the MSM header, the satellite data, and the signal data.

In some embodiments, if the sub-MSM unit including the satellite data and the signal data of the MSM does not have error data, the MSM header may not be modified. The MSM may be directly reconstructed based on the received satellite data, signal data, and the MSM header.

S1206: determining location information of the movable platform based on the MSM.

The detailed methods and principle of step S1206 may be consistent with those of step S903, which are not repeated.

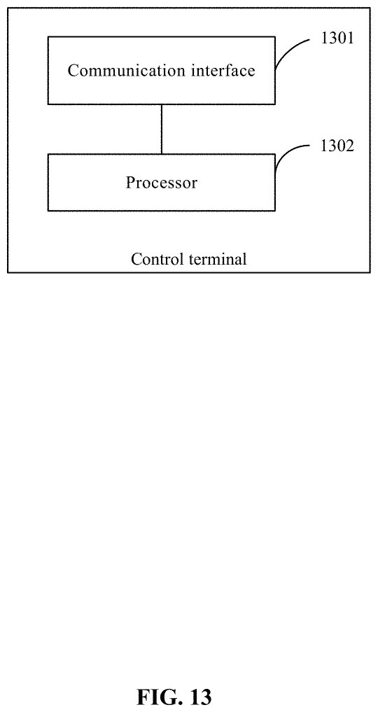

The present disclosure provides a control terminal. The control terminal may be one or more of a dedicated remote controller of a movable platform (e.g., an unmanned aerial vehicle), a smart cell phone, a tablet, a laptop, a ground control station, or a wearable device (e.g., a watch or a wristband). FIG. 13 is a schematic diagram of a control terminal. As shown in FIG. 13, the control terminal may include:

a communication interface 1301 configured to receive an MSM; and

one or more processors 1302 configured to operate independently or in combination to:

construct multiple sub-MSM units based on the MSM; and

transmit the multiple sub-MSM units to the movable platform.

In some embodiments, when the processor 1302 constructs the multiple sub-MSM units based on the MSM, the processor 1302 may be configured to:

constructing, based on the MSM, a sub-MSM unit including the MSM header, and a sub-MSM unit including the satellite data and the signal data of the MSM.

In some embodiments, when the processor 1302 transmits the multiple sub-MSM units to the movable platform, the processor 1302 may be configured to:

transmitting to the movable platform a sub-MSM unit including the MSM header and a sub-MSM unit including the satellite data and the signal data of the MSM.

In some embodiments, when the processor 1302 constructs the sub-MSM unit including the MSM header, and the sub-MSM unit including the satellite data and the signal data of the MSM, the processor 1302 may be configured to:

obtain the MSM header, and construct a sub-MSM unit including the MSM header; and

obtain the satellite data and the signal data of the MSM, and construct a sub-MSM unit including the satellite data and the signal data of the MSM.

In some embodiments, when the processor 1302 constructs the sub-MSM unit including the satellite data and signal data of the MSM, the processor 1302 may be configured to:

Grouping the satellite data and the signal data to determine the satellite data and the signal data corresponding to each satellite, and constructing a sub-MSM unit including the satellite data and the signal data of the MSM based on the satellite data and the signal data corresponding to each satellite.

In some embodiments, the sub-MSM unit including the satellite data and the signal data of the MSM includes identification information. The identification information may be determined based on the satellite numbering.

In some embodiments, the identification information may be located in an empty bit formed when combining the satellite data and the signal data of the sub-MSM unit.

In some embodiments, the processor 1302 may be configured to:

construct the sub-MSM unit including a frame end; and

transmit the sub-MSM unit including the frame end to the movable platform.

In some embodiments, the sub-MSM unit may include a check code.

In some embodiments, the sub-MSM unit may include a frame header.

In some embodiments, when the processor 1302 transmits the sub-MSM unit including the MSM header to the movable platform, the processor 1302 may be configured to:

transmit the sub-MSM unit including the MSM header to the movable platform multiple times.

In some embodiments, when the communication interface 1301 receives the MSM, the communication interface 1301 may be configured to:

receive the MSM transmitted by a wireless network base station.

In some embodiments, when the communication interface 1301 receives the MSM, the communication interface 1301 may be configured to:

receive the MSM transmitted by a radio station of an RTK base station.

In some embodiments, the processor 1302 may be configured to encrypt the sub-MSM unit.

In some embodiments, when the processor 1302 transmits the multiple sub-MSM units to the movable platform, the processor 1302 may be configured to:

transmit multiple encrypted sub-MSM units to the movable platform.

According to the technical solution of the present disclosure, after the communication interface 1301 receives the MSM, the processor 1302 may construct multiple sub-MSM units based on the MSM, and may transmit the multiple sub-MSM units to the movable platform, thereby reducing the correlation between the data of the MSM. After the movable platform receives the multiple sub-MSM units, the movable platform may reconstruct the MSM based on the received multiple sub-MSM units. As such, during the process of the control terminal transmitting the multiple sub-MSM units to the movable platform, if one or more of the multiple sub-MSM units have error data or are lost, the movable platform may still be able to reconstruct the MSM based on other remaining sub-MSM units, thereby increasing the fault tolerance capability and the reliability of the MSM transmission.

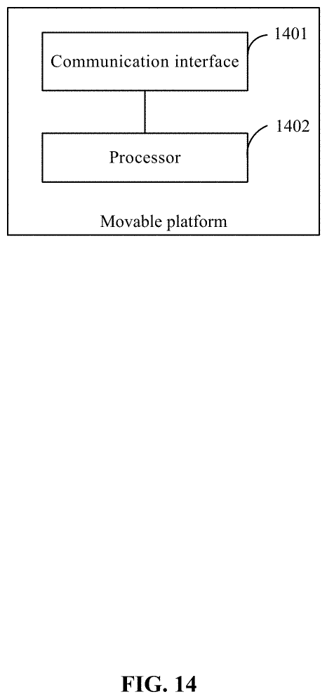

The present disclosure provides a movable platform. FIG. 14 is a schematic diagram of a movable platform. The movable platform may be any of the above-mentioned movable station, such as a ground robot (e.g., a remotely controlled vehicle), an aerial robot (e.g., an unmanned aerial vehicle), a water surface robot (e.g., a remotely controlled boat), etc. As shown in FIG. 14, the movable platform may include:

a communication interface 1401 configured to receive multiple sub-MSM units transmitted by the control terminal;

one or more processors 1402 operating independently or in combination and configured to:

reconstruct the MSM based on the received multiple sub-MSM units; and

determine location information of the movable platform based on the MSM.

In some embodiments, the multiple sub-MSM units may include at least: a sub-MSM unit including the MSM header and a sub-MSM unit including the satellite data and the signal data of the MSM.

In some embodiments, when the processor 1402 reconstructs the MSM based on the received multiple sub-MSM units, the processor 1402 may be configured to:

reconstruct the MSM based on a received sub-MSM unit including the MSM header and a received sub-MSM unit including the satellite data and the signal data of the MSM.

In some embodiments, when the processor 1402 reconstructs the MSM based on the received sub-MSM unit including the MSM header and the received sub-MSM unit including the satellite data and the signal data of the MSM, the processor 1402 may be configured to:

obtain the MSM header included in the sub-MSM unit that includes the MSM header; and

obtain satellite data and signal data included in the sub-MSM unit that includes the satellite data and the signal data of the MSM; and

reconstruct the MSM based on the MSM header, the satellite data, and the signal data.

In some embodiments, satellite data and signal data included in the sub-MSM unit that includes the satellite data and the signal data of the MSM may be the satellite data and the signal data of a satellite included in the MSM.

In some embodiments, when the processor 1402 obtains the satellite data and the signal data included in the sub-MSM unit that includes the satellite data and the signal data of the MSM, the processor 1402 may be configured to:

obtain satellite data and signal data of a satellite from each sub-MSM unit including the satellite data and the signal data of the MSM.

In some embodiments, when the processor 1402 reconstruct the MSM based on the MSM header, the satellite data, and the signal data, the processor 1402 may be configured to:

reconstruct the MSM based on the MSM header and the satellite data and the signal data corresponding to each satellite.

In some embodiments, the processor may be configured to:

determine whether all of the sub-MSM units constructed based on the MSM and including the satellite data and the signal data of the MSM have been received; and

if not all of the sub-MSM units have been received, modify the MSM header.

In some embodiments, when the processor 1402 reconstructs the MSM based on the received multiple sub-MSM units, the processor 1402 may be configured to:

reconstruct the MSM based on a modified MSM header, and the satellite data and the signal data of the received sub-MSM unit.

In some embodiments, the sub-MSM unit including the satellite data and the signal data of the MSM may include identification information. The identification information may be determined based on the satellite numbering.

In some embodiments, when the processor 1402 determines whether all of the sub-MSM units constructed based on the MSM and including the satellite data and the signal data of the MSM have been received, the processor 1402 may be configured to:

obtain identification information of the sub-MSM unit that includes the satellite data and the signal data of the MSM; and

determine whether all of the sub-MSM units constructed based on the MSM and including the satellite data and the signal data of the MSM have been received based on the MSM header and the identification information.

In some embodiments, the sub-MSM unit may include a check code.

In some embodiments, the processor 1402 may be configured to:

determine, based on the check code, whether the received sub-MSM unit including the satellite data and the signal data of the MSM includes error data; and

if the sub-MSM unit includes error data, modify the MSM header.

In some embodiments, when the processor reconstructs the MSM based on the received multiple sub-MSM units, the processor may be configured to:

reconstruct the MSM based on the modified MSM header, and the satellite data and the signal data of the sub-MSM unit that does not include error data.

In some embodiments, when the processor 1402 modifies the MSM header, the processor 1402 may be configured to:

modify one or more of a satellite numbering and a number of signal data of the MSM header.

In some embodiments, when the processor 1402 obtains the identification information included in the sub-MSM unit including the satellite data and the signal data of the MSM, the processor 1402 may be configured to:

obtain the identification information from an empty bit formed when combining the satellite data and the signal data of the sub-MSM unit.

In some embodiments, the multiple sub-MSM units may include a sub-MSM unit including a frame end.

In some embodiments, when the processor 1402 reconstructs the MSM based on the received sub-MSM unit including the MSM header and the sub-MSM unit including the satellite data and the signal data of the MSM, the processor 1402 may be configured to:

after receiving the sub-MSM unit including the frame end, reconstruct the MSM based on the received sub-MSM unit including the MSM header and the sub-MSM unit including the satellite data and the signal data of the MSM.

In some embodiments, the sub-MSM unit may include a frame header (or header).

In some embodiments, the processor 1402 may be configured to: decrypt the received sub-MSM unit based on a predetermined decryption rule.

In some embodiments, when the processor 1402 reconstructs the MSM based on the received multiple sub-MSM units, the processor 1402 may be configured to:

reconstruct the MSM based on multiple decrypted sub-MSM units.

In some embodiments, the movable platform may be an unmanned aerial vehicle.

According to the technical solution of the present disclosure, the movable platform may receive multiple sub-MSM units constructed by the control terminal based on the MSM. The multiple sub-MSM units may be independent from one another. Therefore, when one or more of the multiple sub-MSM units have error data or are lost, the movable platform may still be able to reconstruct the MSM based on the other sub-MSM units, thereby increasing the fault tolerance capability and reliability of the information transmission.

The various embodiments of the present disclosure are described using a gradually increasing method. What are described for each embodiment are the differences with other embodiments. The similar or the same parts of various embodiments may refer to relevant descriptions of each other. For the device of the disclosed embodiments, because it corresponds to the disclosed methods, the descriptions of the disclosed device are relatively simplified. Related functions performed by the device may refer to the descriptions of the relevant methods.

It should be understood that in the present disclosure, relational terms such as “first” and “second,” etc., are only used to distinguish an entity or operation from another entity or operation, and do not necessarily require or imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

From the descriptions of the various embodiments, a person having ordinary skills in the art can understand that the technical solution of the present disclosure may be realized through software and a relevant hardware platform. Based on such understanding, the portion of the technical solution of the present disclosure that contributes to the current technology, or some or all of the disclosed technical solution may be implemented as a software product. The computer software product may be stored in a non-transitory storage medium, such as a read-only memory (“ROM”), a random access memory (“RAM”), a magnetic disk, or an optical disc, etc., which may include instructions or codes for causing a computing device (e.g., personal computer, server, or network device, etc.) to execute some or all of the steps of the disclosed methods.

Based on the above descriptions of the various embodiments of the present disclosure, a person having ordinary skills in the art can realize or use the present disclosure. Various modifications of the embodiments may be obvious to the person having ordinary skills in the art. The general principle defined in the present disclosure may be realized in other embodiments not described herein without falling out of the spirit or scope of the present disclosure. Therefore, the present disclosure is not limited by the various embodiments described herein, but has a broadest scope that is consistent with the principle and novel features of the present disclosure.

What is claimed is:

1. A method, comprising:
receiving a multiple signal message (“MSM”);
constructing multiple sub-MSM units based on the MSM; and
transmitting the multiple sub-MSM units to a movable platform.

2. The method of claim 1,
wherein constructing the multiple sub-MSM units based on the MSM comprises:
constructing, based on the MSM, a sub-MSM unit including an MSM header, and a sub-MSM unit including satellite data and signal data of the MSM, and
wherein transmitting the multiple sub-MSM units to the movable platform comprises:
transmitting to the movable platform the sub-MSM unit including the MSM header and the sub-MSM unit including the satellite data and the signal data of the MSM.

3. The method of claim 2, wherein constructing, based on the MSM, the sub-MSM unit including the MSM header and the sub-MSM unit including the satellite data and the signal data of the MSM comprises:
obtaining the MSM header, and constructing, based on the MSM header, the sub-MSM unit including the MSM header; and
obtaining the satellite data and the signal data of the MSM, and constructing, based on the satellite data and the signal data of the MSM, the sub-MSM unit including the satellite data and the signal data of the MSM.

4. The method of claim 3, wherein constructing, based on the satellite data and the signal data of the MSM, the sub-MSM unit including the satellite data and the signal data of the MSM comprises:
grouping the satellite data and the signal data to determine satellite data and signal data corresponding to each satellite, and constructing the sub-MSM unit including the satellite data and the signal data of the MSM based on the satellite data and the signal data corresponding to each satellite.

5. The method of claim 4, wherein sub-MSM unit including the satellite data and the signal data of the MSM comprises identification information, and wherein the identification information is determined based on a satellite numbering.

6. The method of claim 5, wherein the identification information is located in an empty bit formed when the satellite data and the signal data included in the sub-MSM unit are combined.

7. The method of claim 2, further comprising:
constructing a sub-MSM unit including a frame end; and
transmitting the sub-MSM unit including the frame end to the movable platform.

8. The method of claim 1, wherein at least one of the multiple sub-MSM units includes a check code.

9. The method of claim 1, wherein at least one of the multiple sub-MSM units includes a frame header.

10. The method of claim 2, wherein transmitting the sun-MSM unit including the MSM header to the movable platform comprises:
transmitting the sun-MSM unit including the MSM header to the movable platform multiple times.

11. The method of claim 1, wherein receiving the MSM comprises:
receiving the MSM transmitted by a wireless network base station.

12. The method of claim 1, wherein receiving the MSM comprises:
receiving the MSM transmitted by a radio station of a Real Time Kinematic (“RTK”) base station.

13. The method of claim 1, further comprising:
encrypting the multiple sub-MSM units,
wherein transmitting the multiple sub-MSM units to the movable platform comprises transmitting the encrypted multiple sub-MSM units to the movable platform.

14. A control terminal, comprising:
a communication interface configured to receive a multiple signal message (“MSM”); and
one or more processors configured to operate independently or in combination to:
construct multiple sub-MSM units based on the MSM; and
transmit the multiple sub-MSM units to a movable platform.

15. The control terminal of claim 14,
wherein when the one or more processors construct the multiple sub-MSM units based on the MSM, the one or more processors are configured to:
construct, based on the MSM, a sub-MSM unit including an MSM header, and a sub-MSM unit including satellite data and signal data of the MSM, and
wherein when the one or more processors transmit the multiple sub-MSM units, the one or more processors are configured to:
transmit, to the movable platform, the sub-MSM unit including the MSM header and the sub-MSM unit including the satellite data and the signal data of the MSM.

16. The control terminal of claim 15, wherein when the one or more processors construct, based on the MSM, the sub-MSM unit including the MSM header and the sub-MSM unit including the satellite data and the signal data of the MSM, the one or more processors are configured to:
obtain the MSM header, and construct, based on the MSM header, the sub-MSM unit including the MSM header; and
obtain the satellite data and the signal data of the MSM, and construct, based on the satellite data and the signal data, the sub-MSM unit including the satellite data and the signal data of the MSM.

17. The control terminal of claim 16, wherein when the one or more processors construct, based on the satellite data and the signal data, the sub-MSM unit including the satellite data and the signal data of the MSM, the one or more processors are configured to:
group the satellite data and the signal data to determine satellite data and signal data corresponding to each satellite, and construct the sub-MSM unit including the satellite data and the signal data of the MSM based on the satellite data and the signal data corresponding to each satellite

18. The control terminal of claim 17, wherein the sub-MSM unit including the satellite data and the signal data of the MSM includes identification information, and wherein the identification information is determined based on a satellite numbering.

19. The control terminal of claim 18, wherein the identification information is located in an empty bit formed when the satellite data and the signal data of the sub-MSM unit are combined.

20. The control terminal of claim 14,
wherein the one or more processors are configured to encrypt the multiple sub-MSM units, and
wherein when the one or more processors transmit the multiple sub-MSM units to the movable platform, the one or more processors are configured to: transmit the encrypted multiple sub-MSM units to the movable platform.
